(19) United States
(12) Patent Application Publication
(10) Pub. No.: US 2019/0034475 A1
(43) Pub. Date: Jan. 31, 2019

(54) SYSTEM AND METHOD FOR DETECTING DUPLICATE DATA RECORDS

(71) Applicant: ENIGMA TECHNOLOGIES, INC., New York, NY (US)

(72) Inventors: Urvish Parikh, New York, NY (US); Olga Ianiuk, Brooklyn, NY (US); Nicholas Eli Becker, Summit, NJ (US); William Austin Webb, Brooklyn, NY (US); Maureen Elizabeth Teyssier, Hawthorne, NJ (US); Kelvin K. Chan, Scarsdale, NY (US); Alexis Karina Mikaelian, New York, NY (US); Jarrod Parker, New York, NY (US)

(21) Appl. No.: 16/043,989

(22) Filed: Jul. 24, 2018

Related U.S. Application Data
(60) Provisional application No. 62/538,054, filed on Jul. 28, 2017.

(51) Int. Cl. G06F 17/30; G06N 99/00

(52) U.S. Cl. CPC G06F 17/30371; G06N 99/005; G06F 17/30303; G06F 17/3033

(57) ABSTRACT

Embodiments of the disclosure are directed to providing a single source for adverse event data by taking a layered approach to standardizing, harmonizing and detecting duplicates across multiple data sources at different scales. In one embodiment, a method is provided. The method includes parsing datasets stored in a data store. These datasets are enriched using standardization and normalization. In the candidate duplicates and feature engineering step, the method may join send the data to hashing algorithm to generate candidate duplicates. Features are extracted from each duplicate candidate pair using the term-pair set adjustment technique. These candidates and associate features are sampled using a sampling technique and are labeled as duplicates or non-duplicates. Upon a conflict in labels, a conflict resolution strategy is applied to create a master list of duplicate pairs. A classifier is trained on the master list to classify the rest of the candidate pairs as duplicates/non-duplicates.

### CROSS-REFERENCE TO RELATED APPLICATION

This application claims the benefit of priority from U.S. Provisional Application No. 62/538,054, filed Jul. 28, 2017, the entirety of which is incorporated herein by reference.

### TECHNICAL FIELD

Embodiments of the present disclosure relate generally to computer-based data analytics, and more specifically, but without limitation, to a system and method for detecting duplicate data records.

### BACKGROUND

During the introduction of a new product to market (e.g., a new drug), many companies collect and analyze information to assess and understand any possible harm to users of that product. In some situations, data regarding certain events, such an adverse event (AE) (e.g., adverse reactions to the drug), could be generated with respect to product. Unexpected AEs could arise at any time and put other users of the product at serious risk as well as curtail the life of the product. As part of the introduction of the new product, many companies may gather hundreds of thousands of data records from various traditional and non-traditional sources throughout the preregistration or post-marketing phases of the product.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates a block diagram of a duplicate data record detection processing pipeline according to an implementation of the present disclosure.

FIG. 1B illustrates a memory including data structures to support duplicate data records detection according to an implementation of the present disclosure.

FIG. 2 illustrates an example of an enhanced precision-recall plot graph according to an implementation of the present disclosure.

FIG. 3 illustrates a flow diagram of a method for detecting duplicate data records according to an implementation of the present disclosure.

FIG. 4 illustrates a block diagram of an illustrative a computer system in which implementations may operate in accordance with the examples of the present disclosure.

### DETAILED DESCRIPTION

Implementations of the disclosure relate to a system and method for detecting duplicate data records, for example, data records related to particular events. It is contemplated that the systems and methods described herein may useful in detecting and de-duplicating data records for events related to a number of different situations, such as a clinical study of a new drug, the introduction of a new consumer household product (e.g., a cleaning agent) or for other types of products. Advantages of the present disclosure may provide data de-duplication for use cases where exact matching generates a low fraction of potential matches, and where there is no identifier/key which links records together. The inherent messiness in public data strongly precludes use of a direct matching methodology. Data from free-fill (human completed) forms, which include errors in spelling, missed entries, and other miscellaneous mistakes, is another example which benefits from (or requires) a data deduplication technique like ours. Data which is moved can also generate duplicate records that are not an exact match.

One example of an area in which the benefits of the present disclosure are particularly useful is the potential lift from data deduplication with regard to suspicious activity events, such as in the anti-money laundering/suspicious activity report/bad actor identification use case. People and corporations that are bad actors, rely on the boundaries between e.g. countries, data warehouses, and data records. Direct/simple/rules-based deduplication potentially will not resolve records where a person name contains different middle initials, and/or small changes to addresses, and/or changes to date of birth, etc. Techniques of the present disclosure can group these records together, where other methodologies fail, because they consider all pieces of information available in a record, and can therefore identify all the assets, registrations, transactions, etc. of potential bad actors. Although the techniques of the disclosure may be used in various systems, so as to illustrate the system functionality and corresponding processes for detecting duplicate data records, and not by way of limitation, the methodology of the present disclosure are described with respect to Pharmacovigilance (PV). Pharmacovigilance is the study of adverse reactions to marketed drugs, their assessment and understanding actions to minimize risk to patients.

Efficient and reliable PV processes are critical for allowing pharmaceutical and biotechnology companies to accurately understand and respond to adverse events associated with their drugs, and thus have important implications for managing patient safety, compliance costs and business or reputation risks. An adverse event (AE) is data record related to any untoward medical occurrence in a patient or clinical investigation subject administered a pharmaceutical product and which does not necessarily have a causal relationship with this treatment. Challenges, however, still exist in the AE data world for several reasons that make analyzing adverse events very difficult. These data challenges are further complicated by the extraordinary complexity of adverse event reporting, resulting in many duplicate entries. For example, the duplicate entries related to AEs could occur during clinical trials or be reported by a patient, caregiver, familiar-relation, social media, government agency, doctor, nurse, pharmacist as well as other sources. In some situations, duplicate entries could alter the seriousness and hence reporting timeline of the case. Missed out duplicates could send misleading information to detection systems set up by some companies or government agencies, leading to repetitive and inconsequential processing steps by the systems or false reporting.

Many challenges in detecting and eliminating the duplicate data records may include: (1) Non-standardized reporting requirements whereby AE data is recorded and reported in inconsistent formats. (2) Inconsistent granularity across data through incomplete data entry or even transcription errors. (3) Stale data dictionaries that is neither updated nor standardized across different sources. (4) Various reporting sources that propagate inconsistencies and redundant or duplicate reports. The messiness and duplication of adverse event reports today impede accurate analysis and detection of drug trends and signals. In order to improve these capabilities, and in turn patient safety and manufacturing quality, a cleaned, de-duplicated, and holistic view of adverse events is required.

Implementations of the disclosure address the above-mentioned and other deficiencies by providing a single-source-of-truth for AE data in which a layered approach is taken in standardizing, harmonizing and detecting duplicates across multiple AE data sources at different scales. As an overview, the methodology begins with a series of data transformations and cleanings within and across data sources, to map all AE data to a standardized ontology. Ontology is a data model representation that is formally naming, and defining categories, properties, and relations between certain concepts and data. Implementations of the disclosure then seek to identify likely duplicates in the data by first using Locality-Sensitive-Hashing (LSH) to reduce the duplicate search space. Next, implementations of the disclosure apply a Term Pair Set adjustment algorithm to all pairs of records within the search spaces defined by LSH to generate features for the classification task of determining duplicate record pairs. The Term Pair Set adjustment score for a pair of records indicates similarity and is calculated on the basis of shared and unshared terms, adjusted for the relative frequencies of these terms in the data. Individual Term Pair Set adjustment score components are treated as features in a Random Forest classifier, which ultimately outputs a probability that a given pair of records is a duplicate of each other. Thereupon, the identified duplicates can be de-duplicated or otherwise deleted to improve system performance by, for example, reducing data space as well as uncorrupt any data analysis and detection of AE trends and signals generated by the system.

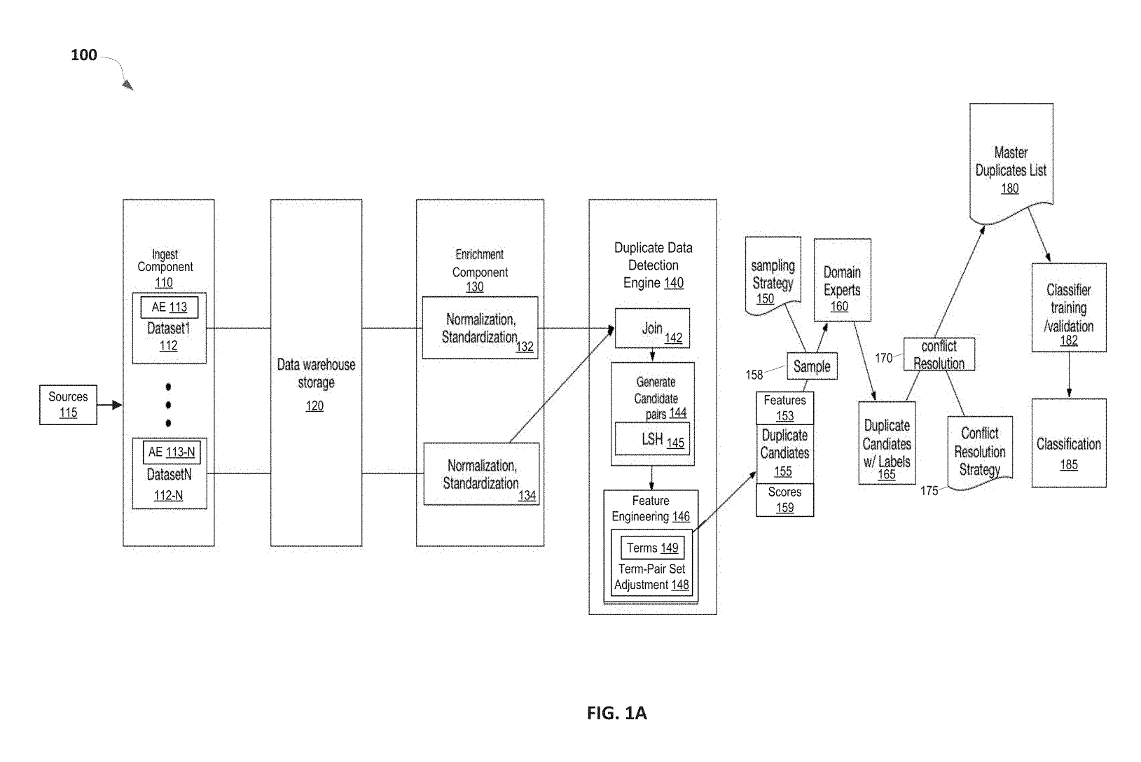

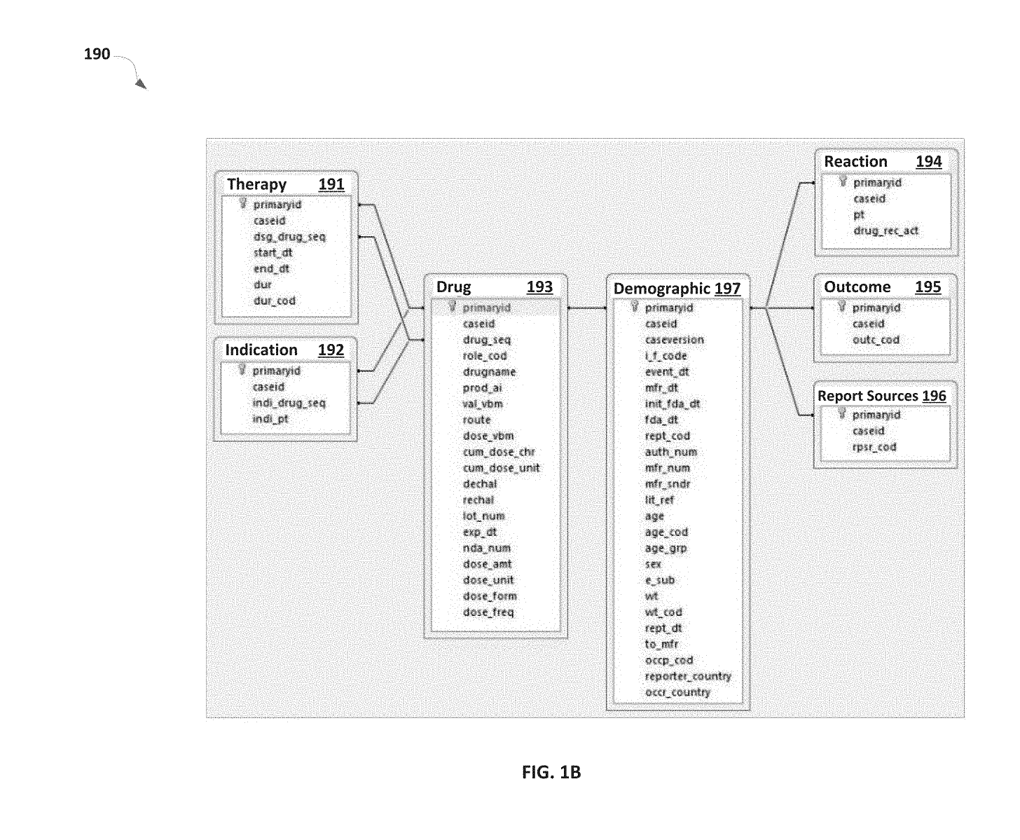

FIG. 1A illustrates a block diagram of a duplicate data record detection processing pipeline 100 according to an implementation of the disclosure. As shown, the processing pipeline 100 may include several components. The components and other features described herein can be implemented as discrete hardware components or integrated in the functionality of hardware components, such as processor, processing device or similar devices. In addition, these components can be implemented as software or functional circuitry within hardware devices. Further, these components can be implemented in any combination of hardware devices and software components.

As a brief summary of the pipeline 100, in the ingest component 110 (also referred to as the data warehousing phase), the duplicate data record detection engine 140 may parse datasets (Dataset1, . . . , DatasetN) 112-112-N stored in a data store (such as data warehouse storage 120). For example, the datasets 112-112N may include data records retrieved from a number of different sources 115 that include, but not limited to, clinical trials, patient reports, caregivers, familiar-relations, social media, government agencies, doctors, nurses, pharmacists as well as other sources. Each of the data sets 112-112N may include at least one of: a complete data record or specified fields of that data record. The duplicate data record detection engine 140 may then enrich these datasets using standardization 132 and normalization 134 techniques. In the candidate duplicates and feature engineering 1146 step, the duplicate data record detection engine 140 may join 142 the data and send to LSH 145 to generate candidate duplicates 155. The duplicate data record detection engine 140 may exact features 153 from each duplicate candidate pair 155 using the Term-Pair Set Adjustment technique 148. These duplicates and associated features 153 are sampled 158 using a sampling technique 150 (and may be domain experts 160) depending on the feature space, and are labeled 165 as duplicates or non-duplicates. Upon a conflict in labels a conflict resolution technique 170 is applied to create a master list 180 of duplicate pairs. A random forest classifier 182 is trained on the master list 180 and a model is used to classify 185 the rest of the candidate pairs. Aspects of these components and techniques are further discussed below.

Each of the data sets 112-112-N ingested in the pipeline 100 may be related to at least one of a number of adverse events 113-113N. An adverse event (AE). 113-113N is any untoward medical occurrence in a patient or clinical investigation subject administered a pharmaceutical product and which does not necessarily have a causal relationship with this treatment. Adverse Events data is a real-world asset for empowering signal detection for patient safety. Unfortunately, available AE data sources (e.g., sources 115) are messy, untimely, and contain numerous duplicates of single cases. With the proliferation of new technologies, varying ontologies, and evolving regulations, AE data continues to grow in volume and complexity. Integrating disparate data into drug safety workflows to run accurate signal detection and prioritize case management now demands not only reliable access to isolated data sources, but confidence in the data itself.

To address these challenges in AE data 113-113N and Pharmacovigilance (PV) workflows, implementations of the disclosure provide a methodology for determining duplicate records within AE reporting data of unprecedented scale and heterogeneity. Implementations of the disclosure combine a sequence of techniques that clean, format, and integrate AE data 113-113N from public and private sources 115, and then probabilistically determine duplicate records both within and across this data to ensure a single-source-of-truth to power more accurate detection and evaluation of safety risks. At a high level, implementations leverage successive filters of precision, both in how the data is processed to detect duplicates and in how the results are presented to the end-user for verification.

### The Data

Implementations of the disclosure may include a processing device (e.g., a central processing unit (CPU) or a hardware processor circuit) to execute duplicate data record detection engine 140 approach to AE data 113-113N from multiple sources 115. Exemplary data sources 115 may include The FDA Adverse Events Reporting System (AERS) (LAERS: 2004-2011, FAERS: 2012-Present), The World Health Organization's (WHO) VigiBase (1968-Present), and private case data.

Implementations of the disclosure may prepare the raw data, such as datasets 112 through 112-N) through a series of cleanings, normalizations 132, as well as additions to the data (code definitions and dictionaries). Further, implementations may standardize 132 the schema within these data sources into a common format that enables us to provide a holistic view of the raw data thru a series of joins. These data standardization techniques 132 not only make it possible for analysts to navigate this data from one source, but also serve to prepare this data for the duplicate data detection pipeline 100.

In the case of the FDA Adverse Events data (AERS), the data preparation work allows the identification of unique records across quarters of data that are released separately. It also enables the detection of “true” duplicates or exact matches between case reports that are owed to bad data ingestion by the FDA. These issues are addressed in subsequent sections.

### Data Preparation

Implementations may include ingesting, using a parsing tool (e.g., Parsekit), the raw data 112 thought 112-N and relevant data dictionaries. This ingestion component 110 is automated and refreshed immediately upon update from the source 115. Once these tables are ingested, the transformations required to produce the training tables needed by the pipeline 100 as well as to generate the curated views constructed for the analyst, are triggered. Upon ingestion, implementations may streamline a process of numerous data cleaning and standardization techniques 132 and 134 that facilitate more accurate linking across cases. These cleaning and standardization techniques 132 and 134 include:
1. Regularizing fields such as dates, age and weight units, into a standard format.
2. Cleaning text strings by removing unnecessary punctuation (i.e. commas, slashes and periods), stripping spaces, lowercasing, etc.
3. Appending description columns to any coded fields.
4. Standardizing country codes.

Implementations may also reference authoritative sources for drug names and side effect categorization to standardize these fields, by:
5. Cleaning and standardizing side effect names according to Medical Dictionary for Regulatory Activities (MedDRA) classifications and appending full MedDRA ontologies for greater granularity. This process warrants further discussion, which is provided below.
6. Cleaning and standardizing drug names according to the National Library of Medicine (NormRX) normalized drug vocabulary.

### MedDRA Standardization

One example of the normalization and standardization techniques 132 and 134 utilize MedDRA (Medical Dictionary for Regulatory Activates) ontologies, which is a data dictionary used by clinicians to record side effects data. MedDRA is organized in taxonomy such that side effects can be coded at different levels of specificity. MedDRA updates bi-annually, wherein terms can be re-classified under different trees with a new release. In AERS, the data is collected at the Preferred Term (PT) level, the second most granular level of specificity. VigiBase uses its own coding standard for side effects (WHO-ART), however, implementations are able to attain corresponding MedDRA LLT (Low-Level Term) and MedDRA PT terms using an existing crosswalk and MedDRA_ID and Adr_ID fields presented in VigiBase.

Implementations may set out to achieve a full MedDRA ontology hierarchy to append to an ultimate view of these datasets. To do so, implementations may begin by normalizing MedDRA dictionaries across the AERS data, by mapping MedDRA PT terms found within the REAC table to the dictionary for the latest version of MedDRA (version 20.0) to extract the higher level terms, MedDRA HLT (Higher Level Term), MedDRA HLGT (High Level Group Term), and MedDRA SOC (System Organ Class) fields associated with these terms to create a complete hierarchy. Implementations may achieve an almost 95% adverse events ontology coverage rate by simply doing a naive string matching on the PT terms in the full batch of FDA data terms against the latest version of MedDRA.

### Training Tables Creation

(A) LAERS to FAERS

To make the data readily analyzable across time periods, implementations may start by resolving differences within the historical data itself. This is an issue only within the AERS, which for time period 2004-2012q3 is known as LAERS, and for period 2012q4-Present is known as FAERS. The primary difference between the two is adjusting for the changes in their schema. To resolve these differences, implementations may map LAERS to the FAERS schema. This process is completed by executing a series of SQL scripts, which creates a stacked view across the entirety of the FDA data by: first, stacking LAERS tables across years, and adding columns that exist in FAERS but not LAERS, and vice versa, for FAERS. Subsequently, implementations may map all LAERS fields to their corresponding fields in FAERS, to create a single AERS view, which will be described in more detail below.

Turning to FIG. 1B, a memory 190 (such as data warehouse storage 120) including data structures 191-197 (e.g., database tables) to support duplicate data records detection is shown. The FDA's ASC_NTS documentation provides guidance on the crosswalk between the legacy LAERS and FAERS schema for these tables. As shown in FIG. 1B, implementations may focus on the following tables:
1. DEMO: Demographics of the patient
2. DRUG (e.g., Drug 193): Which drugs were taken, in what dosage, what brand name, which molecule, etc.
3. INDI (e.g., Indication 192): Gives the diagnosis of the patient, indicating why they took a given drug (this is non-standardized)
4. REAC (e.g., Reaction 194: Resulting side effect reported according to MedDRA standards
5. OUTC (e.g., Outcome 195): Indicates what happened to the patient as a result of the side effect (this is standardized)
6. RPSR (e.g., Report Sources 196): Indicates who reported the adverse event (this is standardized)
7. THER (e.g., Therapy 191): Indicates when the drug was taken, providing guidance on the duration of the side effect

The FDA's ASC_NTS documentation also provides full field descriptions. However it is worth providing some additional context around a few relevant variables within these tables.
Primary ID: identifies a report of a patient experiencing an adverse event. Within FAERS, this ID is a concatenation of caseID and case version.
Case ID: identifies a case of a patient that is experiencing a side effect. Thus, a case ID can be associated with multiple primaryIDs.
Case Version: A case can also have multiple versions, where version 1 corresponds to the initial information provided, and versions 2, 3, 4, etc. represent additional information.

The relationships between these tables and variables are presented in the entity-relationship diagram (ERD) in FIG. 1B.

In order to successfully analyze unique records between different quarters of data, implementations of duplicate data detection engine 140 of FIG. 1 may take an additional step to create a reliable unique index that facilitates these comparisons.

(B) VigiBase to AERS

The creation of training tables for VigiBase is a simpler process than for the AERS data, because of the greater cleanliness of this data and the fact that it strictly follows the conventions of a relational model.

Implementations of duplicate data detection engine 140 of FIG. 1 may use the aforementioned AERS training tables as the backbone to guide the preparation of the training tables for VigiBase. Since the contents of the data tables in VigiBase do not exactly follow that of the AERS tables, implementations may rely on VigiBase's relational model to pull in information from its other related tables in order to make tables that mirror the contents of the AERS tables used herein.

Thus, from the VigiBase data, implementations may use the DEMO and OUTC 195 tables exactly as they appear in the data. However for the DRUG 193, ADR and INDI 192 tables, implementations may need to make some modifications in order to mirror the corresponding DRUG 193, REAC 196 and INDI 192 tables from the FDA data. Implementations may prepare the VigiBase DRUG table 193 through a series of three joins with the Medicinal Product Main File and some subsidiary tables as outlined in the WHODrug-Format C documentation. For VigiBase's ADR table, implementations may join tables ADR and ADR 2 on ADR_ID and then lookup the corresponding MedDRA_ID (WHO-ART) term provided by the official crosswalk to help populate a MedDRA ontology for these records in the manner discussed above. VigiBase's INDI table 192 does not include the UMCReport_ID needed as the primary key to join across tables so implementations may use the relational database mappings of other fields to fetch the corresponding UMCReport_ID for each record from elsewhere in the data.

### Creating a Unique Index

The tables within the AERS data intend to follow a relational model that is explained in the ASC_NTS documentation. However this model has some shortcomings, as it does not provide a unique identifier when comparing data across quarters. This is not an issue for VigiBase, which abides by the conventions of a relational model and provides a reliable primary key (UMCReport_ID).

The FDA further propagates this problem by duplicating some of the cases from the earlier quarters in their data updates, rather than making these updates purely additive. Thus, in the raw data, it is not possible to identify unique records across quarters of data.

Implementations of duplicate data detection engine 140 of FIG. 1 may resolve this issue by creating a surrogate key referred to as the enigma_primaryid. The enigma_primaryid takes the primary_id and concatenates primary_id with the year and quarter to produce a unique index for identifying records across all the AERS data. The creation of this key also enables to identify the aforementioned cases of bad data ingestion and remove these redundant cases from the analysis. With the creation of the key, implementations may be able to stack LAERS and FAERS tables. Implementations can then filter by the latest quarter to distill this data to the latest version of a case, which sets us up to be able to de-duplicate records on the case level, as desired.

### Delivery of Training Tables to Duplicate Detection Pipeline

Once the data sources have been prepared in the manner described above, implementations may put these tables back into the database (e.g., data warehouse storage) to be picked up by duplicate data record detection pipeline 100 for detecting duplicates. Duplicate data record detection pipeline 100 may use the INDI 192, DRUG 193, DEMO, REAC 194 and OUTC 195 tables. Upon receiving these tables, implementations of the pipeline 100 may start by joining between them on their relevant primary key (enigma_primaryid for AERS and UMCReportID for VigiBase), and subsequently applies the layered duplicate detection techniques discussed following sections.

### Delivery of Results

Implementations of duplicate data detection engine 140 of FIG. 1 may present the harmonized view of both AERS and VigiBase data in Assembly with the duplicate data record detection results appended.

### EXAMPLE TECHNIQUES

### Prioritizing Precision

Implementations may start with the premise that an optimal duplicate detection strategy for pharmacovigilance prioritizes precision over recall. Implementations may seek to minimize the number of false positives presented to the analyst. This prioritization represents the most responsible and principled way to apply a probabilistic model in a workflow that can impact patient safety and manufacturing quality decisions.

### Pre-Processing and Ingestion

Given the scale of the addressed data, it is infeasible to do an all-to-all comparison so implementations of the processing pipeline 100 may narrow the scope of comparison while minimizing the number of true duplicates that are excluded. To achieve this, implementations may opt to use Locality-Sensitive-Hashing (LSH) 145 that provides excellent scaling properties.

This technique may reduce the search space to an approximate neighborhood of the most likely potential duplicates. Implementations may then apply Term Pair Set adjustment 148 in these small neighborhoods to detect duplicates at scale to minimize false positives.

Implementations of the processing pipeline 100 may allow the content of the data that needs to be run through duplicate detection be specified by a configuration file that defines the job. The configuration yaml file defines the sources of the datasets that is used. The name of these sources can be registered in a cluster computing system (e.g., spark) so that anytime that name is used in a query (e.g., spark sql query), it refers to the dataset loaded into spark from the url and the format defined (the format can be jdbc, csv, parquet, file or json).

```
Sources:
  - name: “demo”
  url: “jdbc:postgresql://****”
  format: “jdbc”
  options:
    user: “****”
    password: “****”
    dbtable: “aers_demo”
  - name: “drug”
  url: “jdbc:postgresql://****”
  format: “jdbc”
  options:
    user: “****”
    password: “****”
    dbtable: “aers_drug”
  - name: “reac”
  url: “jdbc:postgresql://****”
  format: “jdbc”
  options:
    user: “****”
    password: “****”
    dbtable: “aers_reac”
  - name: “indi”
  url: “jdbc:postgresql://***”
  format: “jdbc”
  options:
    user: “****”
    password: “****”
    dbtable: “aers_indi”
  - name: “outc”
  url: “jdbc:postgresql://***”
  format: “jdbc”
  options:
    user: “****”
    password: “****”
    dbtable: “aers_outc”
```

The Spark SQL query to be run to generate the joined dataset for duplicate detection is also defined in the yaml, this way the user of this pipeline 100 can define whatever columns they want to be considered for duplicate detection.

```
query: “SELECT enigma_primaryid,
      first(occr_country) as occr_country,
      first(age) as age,
      first(sex) as sex,
      to_date(first(event_dt))as event_dt,
      first(age_str) as age_str,
      first(wt_str) as wt_str,
      first(wt) as wt,
      collect_set(pt) as pt,
      collect_set(drugname) as drugname,
      collect_set(drug_rol) as drug_rol,
      collect_set(dose) as dose,
      collect_set(indications) as indications,
      collect_set(outcomes) as outcomes
      FROM
        (SELECT
        enigma_primaryid,
        CONCAT(‘occr_country:’, lower(occr_country))
        AS occr_country,
        CONCAT(‘age:’,round(age), lower(age_cod)) AS age_str,
        CONCAT(‘sex:’, lower(sex)) AS sex,
        event_dt,
        CONCAT(‘wt:’, round(wt), lower(wt_cod)) as wt_str,
        wt,
        age,
        CONCAT(‘reaction:’, lower(pt)) as pt,
        CONCAT(‘drugname:’, lower(drugname)) as drugname,
        CONCAT(‘drug_rol:’, lower(drugname), lower(role_cod)) as
        drug_rol,
        CONCAT(‘dose:’, dose_amt, lower(dose_unit),
lower(dose_freq), lower(dose_form)) as dose,
        CONCAT(‘indication:’, lower(indi_pt)) as indications,
        CONCAT(‘outcomes:’, lower(outc_cod_definition)) as
        outcomes
        FROM
        (SELECT
        *
        FROM
        (SELECT
        *
        FROM
        (SELECT
        *
        FROM
        (
          SELECT
          enigma_primaryid,
          event_dt,
          age,
          sex,
          wt,
          occr_country,
          age_cod,
          wt_cod
          FROM demo where event_dt IS NOT null)
        JOIN drug USING (enigma_primaryid))
        JOIN indi USING (enigma_primaryid))
        JOIN outc USING (enigma_primaryid))
        JOIN reac USING (enigma_primaryid))
        GROUP BY enigma_primaryid”
```

In this case, implementations of the duplicate data record detection engine 140 may join 142 the demo, reac, drug, indi and outc datasets by enigma_primaryID, filtering out records that do not have an event_dt. Assuming that, without this field, a record cannot be uniquely identified. Implementations may also prepend the column name to the fields used for LSH. These fields are (some conjugates): age, sex, event_dt, wt, occur_country, reaction, drugname, role_cod+drugname, dose_amt+dose_unit+dose_freq+dose_form, indi_pt, outcome, with multiple values aggregated as lists.

The configuration file also defines the parameters that are required by LSH 145 and Term Pair Set adjustment 148 as yaml fragments. This pattern allows the pipeline to run independent components (LSH or Term Pair Set adjustment) separately or as a single job which defines their respective parameters as yaml fragments.

```
LSHConf:
  modelDir: “data/model”
  numHashers: 10
  maxHashDistance: 0.5
TPSadjustment:
  limit: −1
  dest: “/opt/share/LSHjob_result”
  fieldWeightsFile: “config/colweights.txt”
  termWeightsFile: “config/termweights.txt”
```

### Locality-Sensitive-Hashing (LSH)

Returning to FIG. 1A, once having joined 142 across tables 191-196 and gathered all the words contained in each record into an unordered list, implementations may then use LSH 145 to randomly generate a hashing function to partition the data.

Implementations may first generate new columns to the dataset terms and pairs which are the bag of word representation of all terms and the pairs of terms in the record. Implementations may generate a SparseVector vector for each record by applying a hash function (e.g., murmur3Hash) instantiated by a seed provided by the configuration file on each element in terms where each hashed element is considered to be an index in the sparse vector.

Implementations may then generate “features” 153 for each SparseVector vector

```
      val mh = new
      MinHashLSH( ).setNumHashTables(jobConf.LSHConf.-
numHashers).setInput Col(“vector”).setOutputCol(“features”).-
setSeed(jobConf.seed)
```

The MinHashLSH object is instantiated with random numbers a,b seeded by jobConf.seed and a prime number p where a,b<p. These random numbers are persistent through the entire run of LSH 145. Thus, each hash function effectively provides a limited set vocabulary (per run) to define each feature in a vector, such that when two vectors are similar their translated hash values may be similar.

Implementations may then fit the dataset to MinHashLSH to create a model.

val model=mh.fit(PVDataset)

The dataset exists in partitioned blocks that are distributed on the workers. Each feature 153 vector in each partition is sent through every hash function, where each hash function takes feature f and performs ((f*a)+b) % p) on it. the minimum of the mapped hash values defined by each hash function is used as an index into a dense vector which is stored in the new column defined by .setOutputCol( ).

Implementations may then calculate an approximate similarity self join using the dense vectors generated by the MinHashLSH model and take only pairs whose jaccard distance is less than what is defined by the Job configuration (default to 0.5).

model.approxSimilarityJoin ( transformed, transformed,
jobConf.LSHConf.maxHashDistance)

Term Pair Set adjustment

To address some of the shortcomings of LSH 145 and generate rich features for classification of duplicates, implementations may further rely on a variant of a Term Pair Set adjustment model 148. Specifically, LSH 145 does not account for the statistics of terms that it matches on—a match on rare terms is no more informative than a match on very common terms, even though intuitively the former should be much more suggestive of duplication.

Implementations may compare records based on the terms 149 they contain. A “term” 149 is a discrete text string corresponding to a standardized medical term, such as a drug name, active ingredient, indication (condition a drug was prescribed for), reaction (medical event), and or drug role (such as “primary suspect” or “concomitant”). Implementations also include country of origin codes and sex as term categories.

Another key assumption is that the rarer the term 149 shared by two records, the more likely the records are to be duplicates. Given this assumption, implementations may assign more weight to rare terms than to common ones when evaluating the likelihood of a pair of records being duplicate. Information Content (I for short) is a natural choice to capture this consideration, and is defined as:

$$I ( term ) = {log}_{2} \frac{1}{p ( term )}$$

where p(term) is the fraction of records that contain a given term 149 divided by the total number of records. Thus, this expression is larger for rarer terms 149. In some implementations, a score 159 for the duplicate candidate pair is generated based on the one or more terms 149. For example, the score 159, assigned to a pair of records, is the sum of information contents of all shared terms 149 minus the information contents of terms 149 that appear in only one record, as well as some correction factors to be discussed below. The higher the score 159 (e.g., a score satisfying a determined threshold level), the more likely the records are to be duplicates.

Implementations may also account for the fact that certain terms 149 are strongly correlated. For instance, “aspirin” and “headache” frequently appear together. A pair of records, having such a pair of terms 149 in common, is less likely to be duplicates than the sum of the individual information contents of these terms 149 would imply. To mitigate this issue and reduce the number of false positives presented to the analyst, implementations may adjust the score by subtracting out the pairwise information component (related to mutual information) from the overall score. For example:

$$HitMiss = I ( aspirin ) + I ( headache ) - 0.1 * IC ( aspirin , headache )$$

$$where , \\ IC ( term 1 , term 2 ) = log \frac{p \{ term 1 , term 2 \}}{p ( term 1 ) * p ( term 2 )}$$

where p(term1,term2) is the fraction of records containing both term1 and term2 divided by the total number of records. This measure has several desirable properties. Notice that if term1 and term2 are statistically independent, that is, p(term1, term2)=p(term1)*p(term2), then IC(term1,term2)=0. Note that to avoid excessively penalizing records with many common terms 149, implementations may multiply the IC by a corrective term less than 1, in this case, 0.1, which are determined experimentally. This deviates from the more common practice, but produces better results.

More generally, the Term Pair Set adjustment 148 score assigned to a pair of records under model is:

HitMiss=ΣₓI(x)∈ Shared−Σ_{x,y}IC(x,y)∈ Shared−ΣₓI(x)∈ Disjoint

where the first summation captures the scores 159 assigned for shared terms x, less the sum of the IC correlation factors for a pair of terms x, y in the records, and less the sum of the scores assigned to the disjoint terms the records do not share. This approach ignores correlations between larger groups of terms, but accounting for these would result in substantially higher computational overhead and implementations may opt to ignore them.
Training the Term Pair Set adjustment Model

Training the Term Pair Set adjustment model 148 reduces to calculating I(term) for every term 149 and IC(term1,term2) for each term1 and term2 in the dataset that appear in the same row.

These information theoretic quantities are calculated from counts over the data. Calculating I reduces to counting the frequencies of all terms in the dataset. It is almost exactly like the word count computation so often used as the “Hello World” example for MapReduce and other distributed computation technologies.

These examples are generally presented a map and reduce operations, in the case of Apache Spark, as map and reduce using RDDs. However, doing this using RDDs may ran into memory problems. So, implementations may take advantage of the extensive optimizations present in Spark DataFrames.

The computation of IC reduces to counting over all pairs of terms in the dataset that appear in the same row. This is comparable to the computation of I but with even higher memory requirements.

To calculate I and IC, implementations apply a transformation to the dataset the turns each row into a dataframe with column terms that contains the set of terms 149 from the row and a column pairs that contains the set of term pairs (using lexicographic ordering to avoid duplication, i.e. recording both (x,y) and (y,x))

```
      val with_pairs_and_terms = termerize(df, “terms”,
      jobConf.excludedColumns).withColumn(
          “pairs”, generatePairsFromTerms($“terms”)).select(col(primaryid), $“pairs”,
      $“terms”)
          .withColumn(“pair_counts”, lit(1.0)).withColumn(“term_counts”, lit(1.0))
          .as [(String, Array[(String, String)], Array[String], Double, Double)]
      val pair_counts =
      with_pairs_and_terms.select(functions.explode($“pairs”).as(“pairs”).as[(String,
      String)], $“pair_counts”.as[Double]).
          groupBy($“pairs”).agg(sum($“pair_counts”).as(“pair_totals”)).
          select($“pairs”.as[(String, String)], $“pair_totals”.as[Double])
      val term_counts = with_pairs_and_terms.
          select(
            functions.explode($“terms”).as[String].as(“terms”), $“term_counts”).
          groupBy($“terms”).agg(sum($“term_counts”).as(“term_totals”)).
          select($“terms”.as[String], $“term_totals”.as[Double])
```

To count the items in a column, be terms or pairs of terms, implementations may use the explode function to split a row with a set entry into a set of rows with an individual item per row, create a count column initialize to 1, then do a groupBy( . . . ).agg(sum( . . . )) to get overall counts.

I for each term 149 is then calculated from term counts and IC for each pair from both pair counts and term counts. These are stored in separate tables.

### Applying the Model

With the two tables mentioned previously, scoring each candidate row pair produced by LSH 145 is a similar sequence of explode, join, and groupBy.agg(sum( . . . )) operations. LSH 145 outputs a dataframe containing pairs of candidate duplicates 144 in the form of a pair of IDs (each ID in its own column) with each IDs corresponding set of terms and set of enumerated term pairs (each set in its own column). This table is then transformed to one with three additional columns, one for terms shared between records, one for terms not shared between records, and one for the set of all pairs enumerated from the shared terms.

These correspond to the three parts of the score 159, specifically, the addition to the score 159 from shared terms 149, and the penalty for unshared terms and for pairs of correlated terms. The shared term score 159 is calculated per record pair by exploding the shared terms column, joining on the term scores (I) table, and then aggregating the sum. The disjoint term penalty is calculated similarly, and the correlation penalty is analogous, though joined with the pair scores table (IC). Each component is put in its own column, and the final score 159 is a simple row operation that combines them as per the above equation.

The Term Pair Set adjustment score 159 per row has proven to be a very useful metric for likelihood of duplication. However, for many interesting cases, it is informative to examine all components of the score 159. Specifically, for records with very many terms and high overlap, the penalty for correlated pairs can become excessively harsh, and push down records that are clearly good matches. The various components of the score 159 have, in initial experiments, proven very useful as features for a simple binary classifier, which can learn the context-specific meaning of each component and produce more accurate judgments than the combined Term Pair Set adjustment score 159.

Additionally, differences between numerical fields, such as, age, weight, and event date, are useful features. Specifically, if differences are not 0, duplication becomes less likely. Term Pair Set adjustment models in the literature often incorporate numerical difference information directly into the score 159, usually giving a large reward for exact matches, a small reward for very small differences, and a penalty for large differences. As above, it may be more useful to keep each individual numerical difference separate for use as a classifier feature.

### Acquiring Labeled Data

Domain experts 150 may hand label a small, initial batch of data with the sampling strategy described herein.

### Supervised Classification Technique

When training a data model to classify labels for the duplicate candidates, most statistical models fall into one of three groups: supervised, unsupervised, or semi-supervised learning. In supervised learning, the goal is usually to train a model that minimizes a cost function by learning from labeled data. In unsupervised learning, there is no labeled data. Because of that, models are often trained to recognize surface-level or latent structure and evaluate observations based on that structure. In semi-supervised learning tasks, acquiring more than just a tiny bit of labeled data is usually onerous and often requires domain expertise. As a result, a model is built or parameterized with a tiny amount of labeled data.

Because initially there lacks a ground truth (training data), the Term Pair Set adjustment 148 is used as an unsupervised technique. Further analysis reveals a number of subtleties, and later access to training data made it clear that the Term Pair Set adjustment score 159 components can be used as features in a supervised model.

In one implementation, a Random Forest is used for the supervised portion of the duplicate detection pipeline 100. A Random Forest is an ensemble machine learning technique, comprising a combination of individually learned decisions trees.

In the model, a label is predicted for every pair of records by each decision tree. Then, a final decision about the classification (duplicate or non-duplicate) is made in one of two ways: 1) taking the majority class label from the group of decision trees; or 2) taking the class label with the highest average probability across the decision trees in the forest. At a high level, the key insight driving the broad adoption of this algorithm is that a large number of similar, but randomly differing, decisions trees can be aggregated to create a more effective and general learning algorithm.

In the use case, random forests are particularly appropriate. Duplicates can be represented by multiple combinations of the three Term Pair Set adjustment features and the three numerical field differences, such that a linear decision boundary would not pick up on all of the variation to be captured. Random Forests are also naturally less prone to overfitting by design. Because of just starting to receive training data, avoiding overfitting is an important concern.

Due to the need to supply a fairly large number of pairs labeled as non-duplicates, selecting examples by hand is impractical. Instead, implementations elect to randomly sample 158 from a subset of the pairwise comparisons, increasing the risk of mislabeled data initially. Random Forests (and bootstrap aggregation algorithms in general), are less sensitive to mislabeled data in the training process than boosting based ensemble techniques.

Finally, random forests are fairly easy to digest. At its core, a random forest is a combination of simple, rules based learning algorithms.

### Evaluation Framework

When determining duplicate candidate pair labels 165, the Random Forest model does not just output a label (duplicate or non-duplicate). It outputs a probability that a given pair of records is a duplicate. Often, this is viewed as a measure of the model's confidence that the given pair of cases is a duplicate. To get the predicted class from a probability, implementations may need to pick a cutoff at which to round up to 1 (representing duplicates) or down to 0 (representing non-duplicates). Implementations could choose the cutoff that maximizes accuracy, but the use-case more naturally aligns with other techniques.

Two commonly used techniques to measure performance in more fine-tuned ways are the area under the Receiver Operating Characteristic curve and the Precision-Recall curve. Because adverse event deduplication is an imbalanced data problem and the desire to avoid false positives, using a precision-recall curve is more appropriate than an ROC curve.

In a precision-recall curve, precision (the percentage of the predicted duplicates that are actually duplicates) is on the y-axis. Recall (the percentage of the total number of true duplicates successfully predicted to be duplicates) is on the x-axis. The precision-recall curve illustrates the model's precision-recall tradeoff as a function of the cutoff threshold at which point to round up (to duplicate) or to round down (to non-duplicate). If implementations care exclusively about precision, implementations may classify a pair as duplicates only if the model outputs a probability above a determined threshold level, such as 0.99, for example. If implementations care exclusively about recall, implementations may provide a lower threshold level to allow capture as many of the true duplicates as possible.

### Results

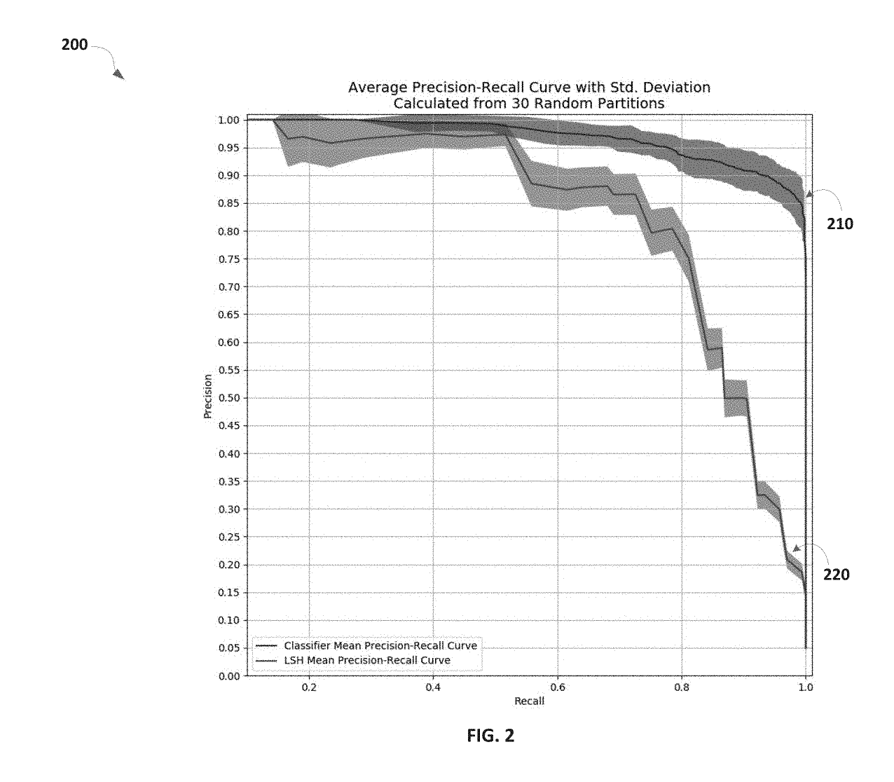

FIG. 2 illustrates an enhanced precision-recall plot graph 200 (derived from out of sample predictions) shows the lift of the Term Pair Set adjustment plus Random Forest pipeline 210 compared to using only the similarity score from Locality Sensitive Hashing 220. The Random Forest model's curve 210 is almost always higher or equal to the LSH 220 similarity score, indicating that for any given level of precision implementations may capture more (or at least as many) of the actual number of duplicates in the data. Succinctly, the Term Pair Set adjustment plus Random Forest pipeline lets us find more of the true duplicates in the data without getting more false-positives. As shown in FIG. 2, the technique using the Random Forest classifier consistently achieves notably greater recall while maintaining a comparable or greater level of precision.

With more expert-labeled data, the classifier may be increasingly able to discern duplicates from non-duplicates. The robustness of the precision-recall curves may increase, and Implementations may be able to make an informed decision about the probability threshold to use to go from predicting to duplicates pairs to creating a de-duplicated dataset.

### Priors Based Decision Tree Iterative Sampling

Implementations may include a feature-aware sampling technique to leverage domain knowledge of the feature space while preserving the ability to identify duplicates in unexpected places. This technique involves multiple iterations of data curation and domain expert labeling. Assume a predefined limit in the number of observations provided to domain experts per iteration, called N.

Implementations may begin with a widely spread space, composed of both data sampled completely at random and of data drawn randomly from “pockets” of the feature space the statistical properties of the features suggest may contain duplicates.

In each successive round of expert labeling, the possible feature space of duplicates is iteratively refined until the feature space of duplicates is plausibly identified. If the random sample surfaces new combinations of the feature space that may be a “pocket”, these newly identified pockets are elevated to receive targeted sampling in line with the initially identified ones.

After each round, pockets are partitioned into subspaces from which a decision boundary is identified. Observations closer to the decision boundary in a given pocket are relatively more likely to be surfaced for expert labeling in the next round. Upon feature space exhaustion, the fraction of the N total observations assigned to this pocket is reallocated to the random sample portion or to newly identified pockets. As the number of labeling iterations increases, on expectation implementations may be able to identify the set of possible spaces in which duplicates can exist based on the expert labeling.

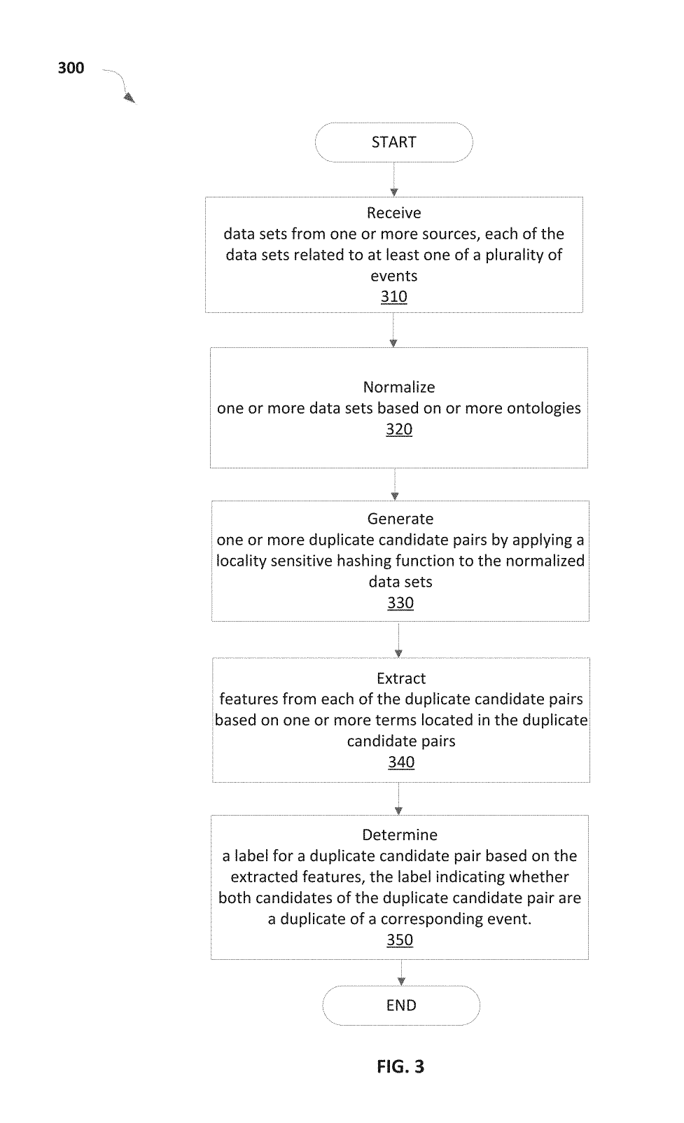

FIG. 3 illustrates a flow diagram of a method 300 for detecting duplicate data records according to an implementation of the present disclosure. In one implementation, the duplicate data detection engine 140 of FIG. 1 may perform method 300. The method 300 may be performed by processing logic that may comprise hardware (circuitry, dedicated logic, etc.), software (such as is run on a general purpose computer system or a dedicated machine), or a combination of both. Alternatively, in some other implementations, one or more processors of the computer device executing the method may perform routines, subroutines, or operations may perform method 300 and each of its individual functions. In certain implementations, a single processing thread may perform method 300. Alternatively, two or more processing threads with each thread executing one or more individual functions, routines, subroutines, or operations may perform method 300. It should be noted that blocks of method 300 depicted in FIG. 3 can be performed simultaneously or in a different order than that depicted.

Referring to FIG. 3, in block 310, method 300 receives data sets from one or more sources. Each of the data sets related to at least one of a plurality of events. In block 320, one or more datasets are normalized based on one or more ontologies. In block 330, one or more duplicate candidate pairs are generated by applying a locality sensitive hashing function to the data sets. In block 340, features are extracted from each of the duplicate candidate pairs based on one or more terms located in the duplicate candidate pairs. In block 350, a label is determined for a duplicate candidate pair based on the extracted features, the label indicating whether both candidates of the duplicate candidate pair are a duplicate of a corresponding adverse event.

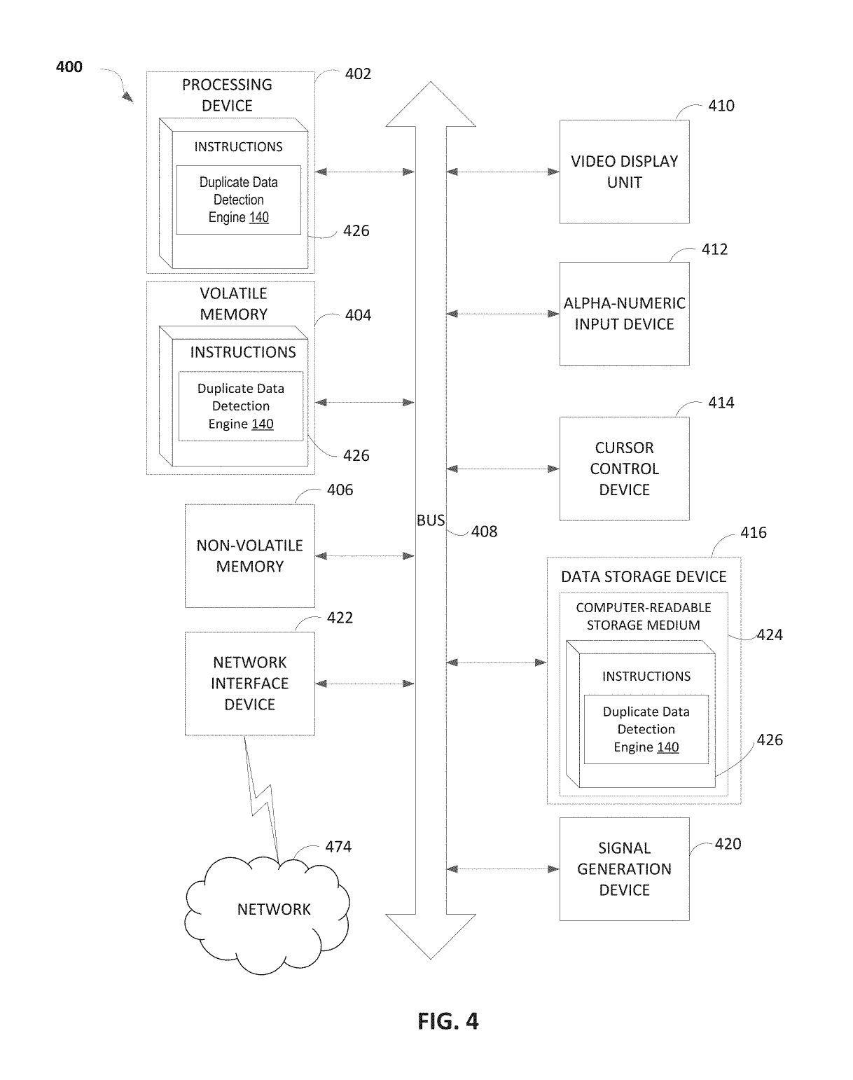

FIG. 4 depicts a block diagram of an illustrative of a computer system 400 in which implementations may operate in accordance with one or more examples of the present disclosure. In various illustrative examples, computer system 400 may correspond to a processing device within system architecture, such as processing device of the processing pipeline 100 of FIG. 1.

In certain implementations, computer system 400 may be connected (e.g., via a network, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 may include a processing device 402, a volatile memory 404 (e.g., random access memory (RAM)), a non-volatile memory 406 (e.g., read-only memory (ROM) or electrically-erasable programmable ROM (EEPROM)), and a data storage device 416, which may communicate with each other via a bus 408.

Processing device 402 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 may further include a network interface device 422. Computer system 400 also may include a video display unit 410 (e.g., an LCD), an alphanumeric input device 412 (e.g., a keyboard), a cursor control device 414 (e.g., a mouse), and a signal generation device 420.

Data storage device 416 may include a non-transitory computer-readable storage medium 424 on which may store instructions 426 encoding any one or more of the methods or functions described herein, including instructions 426 encoding the duplicate data detection engine 140 of FIG. 1 for implementing method 300 of FIG. 3 for detecting duplicate data records.

Instructions 426 may also reside, completely or partially, within volatile memory 404 and/or within processing device 402 during execution thereof by computer system 400, hence, volatile memory 404 and processing device 402 may also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “normalizing,” “generating,” “extracting,” “determining,” “adjusting,” “detecting,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appears as set forth in the description below. In addition, the disclosure is not described with reference to any particular programming language. It is appreciated that a variety of programming languages may be used to implement the teachings of the disclosure as described herein.

The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it may be recognized that the present disclosure is not limited to the examples and implementations described. The scope of the disclosure should be determined with reference to the following claims, along with the full scope of equivalents to which the claims are entitled.

What is claimed is:

1. A method comprising:
receiving, by a processing device, data sets from one or more sources, each of the data sets related to at least one of a plurality of events;
normalizing, by the processing device, one or more datasets based on one or more ontologies;
generating, by the processing device, one or more duplicate candidate pairs by applying a locality sensitive hashing function to the normalized data sets;
extracting, by the processing device, features from each of the duplicate candidate pairs based on one or more terms located in the duplicate candidate pairs; and
determining, by the processing device, a label for a duplicate candidate pair based on the extracted features, the label indicating whether both candidates of the duplicate candidate pair are a duplicate of a corresponding event.

2. The method of claim 1, wherein each of the data sets comprises at least one of: a complete data record or specified fields of the data record.

3. The method of claim 1, further comprising:
generating a score for the duplicate candidate pair based on the one or more terms; and
determining that the duplicate candidate pair is a duplicate for the corresponding event based on the score and a classifier.

4. The method of claim 1, further comprising:
adjusting the score for the duplicate candidate pair based on a measure of a first term and a second term being in both candidates of the duplicate candidate pair.

5. The method of claim 1, further comprising:
detecting a conflict between the label and a classification for the duplicate candidate pair.

6. The method of claim 5, further comprising:
updating a list of duplicate candidate pairs based on a resolution of the conflict.

7. The method of claim 6, further comprising:
training, based on the list, a data model to classify other candidates of the duplicate candidate pair as at least one of: a duplicate or non-duplicate.

8. A system comprising:
a memory, and
a processing device, operatively coupled to the memory, to:
receive data sets from one or more sources, each of the data sets related to at least one of a plurality of events;
normalize one or more datasets based on one or more ontologies;
generate one or more duplicate candidate pairs by applying a locality sensitive hashing function to the normalized data sets;
extract features from each of the duplicate candidate pairs based on one or more terms located in the duplicate candidate pairs; and
determine a label for a duplicate candidate pair based on the extracted features, the label indicating whether both candidates of the duplicate candidate pair are a duplicate of a corresponding event.

9. The system of claim 8, wherein each of the data sets comprises at least one of: a complete data record or specified fields of the data record.

10. The system of claim 8, wherein the processing device is further to:
generate a score for the duplicate candidate pair based on the one or more terms; and
determine that the duplicate candidate pair is a duplicate for the corresponding event based on the score and a classifier.

11. The system of claim 8, wherein the processing device is further to:
adjust the score for the duplicate candidate pair based on a measure of a first term and a second term being in both candidates of the duplicate candidate pair.

12. The system of claim 8, wherein the processing device is further to:
detect a conflict between the label and a classification for the duplicate candidate pair.

13. The system of claim 12, wherein the processing device is further to:
update a list of duplicate candidate pairs based on a resolution of the conflict.

14. The system of claim 13, wherein the processing device is further to:
train, based on the list, a data model to classify other candidates of the duplicate candidate pair as at least one of: a duplicate or non-duplicate.

15. A non-transitory computer-readable medium comprising executable instructions that, when executed by a processing device, cause the processing device to:
receive, by the processing device, data sets from one or more sources, each of the data sets related to at least one of a plurality of events;
normalize one or more datasets based on one or more ontologies;
generate one or more duplicate candidate pairs by applying a locality sensitive hashing function to the normalized data sets;
extract features from each of the duplicate candidate pairs based on one or more terms located in the duplicate candidate pairs; and
determine a label for a duplicate candidate pair based on the extracted features, the label indicating whether both candidates of the duplicate candidate pair are a duplicate of a corresponding event.

16. The non-transitory computer-readable medium of claim 15, wherein each of the data sets comprises at least one of: a complete data record or specified fields of the data record.

17. The non-transitory computer-readable medium of claim 15, wherein the processing device is further to:
generate a score for the duplicate candidate pair based on the one or more terms; and
determine that the duplicate candidate pair is a duplicate for the corresponding adverse event based on the score and a classifier.

18. The non-transitory computer-readable medium of claim 15, wherein the processing device is further to:
adjust the score for the duplicate candidate pair based on a measure of a first term and a second term being in both candidates of the duplicate candidate pair.

19. The non-transitory computer-readable medium of claim 15, wherein the processing device is further to:
detect a conflict between the label and a classification for the duplicate candidate pair.

20. The non-transitory computer-readable medium of claim 19, wherein the processing device is further to:
updating a list of duplicate candidate pairs based on a resolution of the conflict.
